(19) United States
(12) Patent Application Publication
(10) Pub. No.: US 2009/0152082 A1
(43) Pub. Date: Jun. 18, 2009

(54) APPLIANCE BUTTON

(75) Inventor: Adam Hanes, Glen Allen, VA (US)

Correspondence Address: PANITCH SCHWARZE BELISARIO & NADEL LLP, ONE COMMERCE SQUARE, 2005 MARKET STREET, SUITE 2200, PHILADELPHIA, PA, 19103, US

(73) Assignee: HAMILTON BEACH BRANDS, INC., Glen Allen, VA (US)

(21) Appl. No.: 12/236,577

(22) Filed: Sep. 24, 2008

Related U.S. Application Data
(63) Continuation-in-part of application No. 11/958,473, filed on Dec. 18, 2007.

(51) Int. Cl. H01H 1/06

(52) U.S. Cl. 200/276.1

(57) ABSTRACT

An appliance button for use in an appliance having a housing, a button opening in the housing and a control structure within the housing includes a button that has a longitudinal axis. A distal end of the button extends outwardly through the button opening in the housing. A button stem is located within the housing and is generally co-axially aligned with the button. A first end of the button stem is operably connected to the control structure and a second end is operably connected to the button. A deflector is mounted on the button between the control structure and the housing and extends radially outwardly from the button to direct liquid away from the button stem.

### CROSS-REFERENCE TO RELATED APPLICATIONS

This application is a continuation-in-part application of U.S. patent application Ser. No. 11/958,473 filed Dec. 18, 2007 entitled “Appliance Button”.

### BACKGROUND OF THE INVENTION

This invention generally relates to an appliance button and, more particularly, to an appliance button having a deflector for preventing liquid from contacting the internal electrical components of the appliance.

Kitchen appliances such as mixers, blenders and food processors contain electrical components. Because such appliances are often exposed to liquid through overfills, spills and attempts to clean the exterior, it is desirable to provide an outer housing that safely shields the electrical components from such liquid to prevent shortages, corrosion and electric shock. However, appliances with push buttons often have a plurality of button openings in the housing. The button openings prevent the housing from having a water-tight seal and allow liquid that is running down the exterior of the housing to enter the interior of the housing.

In order to prevent liquid from reaching the electrical components, a thin protective cover is often used to cover the electrical components within the housing. The cover typically blocks a high enough percentage of liquid to allow the appliance to pass the safety requirements set forth by the Underwriters Laboratory (UL). However, due to surface tension and other factors, liquid may still run down the button stem between the button stem and the cover to contact the electrical components. Liquid slips past the cover especially in heavy liquid flow scenarios, not tested by the UL standards.

What is therefore desirable, is an appliance button that reduces the likelihood that liquid entering the housing through the button openings will contact the electrical components of the appliance.

### BRIEF SUMMARY OF THE INVENTION

Briefly stated, the present invention is directed to an appliance button for use in an appliance having a housing, a button opening in the housing and a control structure within the housing and includes a button that has a longitudinal axis. A distal end of the button extends outwardly through the button opening in the housing. A button stem is located within the housing and is generally co-axially aligned with the button. A first end of the button stem is operably connected to the control structure and a second end is operably connected to the button. A deflector is mounted on the button between the control structure and the housing and extends radially outwardly from the button to direct liquid away from the button stem.

### BRIEF DESCRIPTION OF THE SEVERAL VIEWS OF THE DRAWINGS

The foregoing summary, as well as the following detailed description of preferred embodiments of the invention, will be better understood when read in conjunction with the appended drawings. For the purpose of illustrating the invention, there is shown in the drawings embodiments which is presently preferred. It should be understood, however, that the invention is not limited to the precise arrangements and instrumentalities shown.

In the drawings:

FIG. 1 is a perspective view of a plurality of appliance buttons within an appliance housing in accordance with a first preferred embodiment of the present invention;

FIG. 2 is an enlarged perspective view of the plurality of appliance buttons shown in FIG. 1 attached to a control structure;

FIG. 3 is a cross sectional side elevational view of one of the plurality of appliance buttons attached to the control structure shown in FIG. 2 taken along line 3-3 of FIG. 2;

FIG. 4 is a perspective view of an appliance button within an appliance housing in accordance with a second preferred embodiment of the present invention;

FIG. 5 is an enlarged perspective view of the appliance button shown in FIG. 4 attached to a control structure; and

FIG. 6 is a cross sectional side elevational view of the appliance button shown in FIG. 4 taken along line 6-6 of FIG. 4.

### DETAILED DESCRIPTION OF THE INVENTION

Certain terminology is used in the following description for convenience only and is not limiting. The words “right,” “left,” “lower” and “upper” designate directions in the drawings to which reference is made. The words “inwardly” and “outwardly” refer to directions toward and away from, respectively, the geometric center of an appliance button in accordance with the present invention, and designated parts thereof. Unless specifically set forth herein, the terms “a”, “an” and “the” are not limited to one element but instead should be read as meaning “at least one”. The terminology includes the words noted above, derivatives thereof and words of similar import.

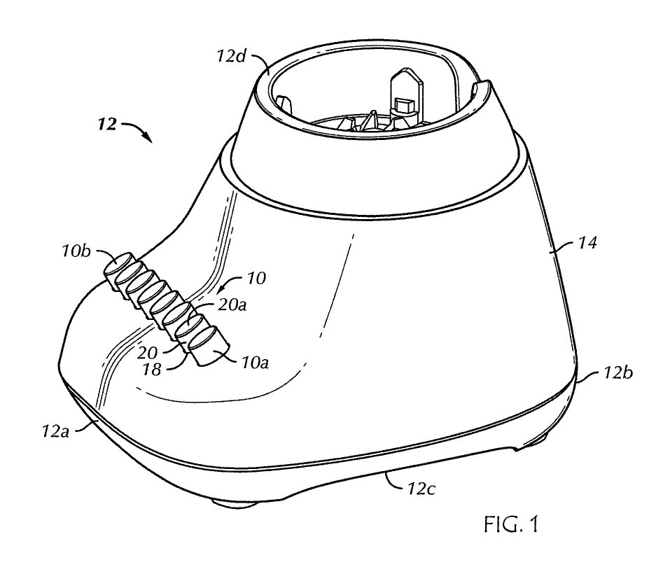

Referring to the drawings in detail, where like numerals indicate like elements throughout, there is shown in FIGS. 1-3 a first preferred embodiment of an appliance button, generally designated 10, for use in an appliance, generally designated 12. The appliance 12 is preferably a blender for blending and mixing foodstuff (not shown). However, the appliance 12 may be any electrical device having buttons that are subjected to liquid exposure such as but not limited to food processors and stereos.

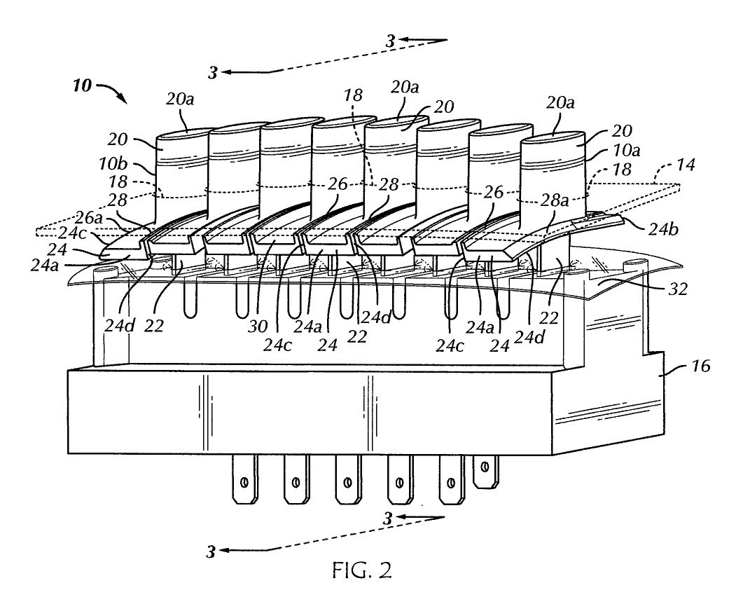

Referring to FIG. 1, the appliance 12 includes a housing 14. The housing 14 serves as a decorative body as well as a protective outer shell to protect a control box or structure 16 (FIG. 2) containing the electrical components within the housing 14. The details of the control structure 16 and the electrical components are omitted for convenience only, as such detail is well known in the art, and omission of such detail is not limiting. The appliance 12 has a front end 12a a rear end 12b a bottom 12c for resting on a planer support surface (not shown) and a top 12d. The appliance 12 and the housing 14 may have any shape and configuration. The housing 14 includes a plurality of generally oval shaped button openings 18 for receiving a plurality of corresponding appliance activating or control buttons 10. The plurality of appliance buttons 10 are preferably similar with the exception of the outermost appliance buttons 10a, 10b described further below.

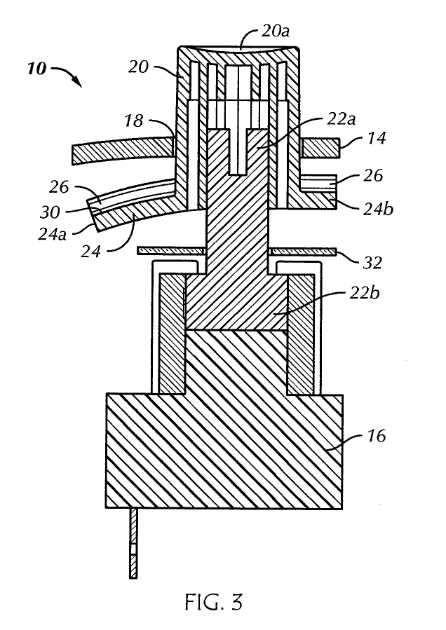

Referring to FIGS. 2-3, the appliance buttons 10 are each comprised of a push button 20. A distal end 20a of each push button 20 extends outward/upwardly through the corresponding button opening 18 in the housing 14. The push buttons 20 are preferably at least slightly smaller than the size of the button openings 18 such that the push buttons 20 can slide in and out of the housing 14. The push buttons 20 preferably have a generally oval cylindrical shape and are preferably molded from a polymeric material. However, the push buttons 20 may be comprised of any shape such as rectangular and be comprised of any suitable material.

Each appliance button 10 includes a button stem 22. The button stem 22 is substantially positioned within the housing 14 and is inline with the corresponding push button 20. Each push button 20 is mounted over a distal end 22a of the corresponding button stem 22. The push button 22 is preferably slidingly attached to the button stem 22. However, the push button 20 may be secured to the button stem 22 in any manner such as a snap fit, use of adhesive or that the push button 20 and the button stem 22 be integrally formed. A proximal end 22b of the button stem 22 is operably connected to a device such as a switch within the control structure 16. As the button stem 22 is urged vertically downwardly into the control structure 16 the button stem 22 activates the electrical switch (not shown) to operate one or more predetermined functions of the appliance 12. The button stem 22 is preferably rectangularly shaped and thin having smaller horizontal dimensions than the push button 20. However, the button stem 22 may have any shape and be sized equal to or larger than the push button 20.

The appliance button 10 further includes a deflector 24. The deflector 24 is located within the housing 14 and is positioned between the button stem 22 and the push button 20. The push button 20 and the deflector 24 are preferably co-molded such the push button 20 and the deflector 24 are integrally formed. However, the push button 20 and deflector 24 may be comprised of separate components that are assembled together after being manufactured.

The deflector 24 preferably extends laterally further than the push button 20 and the button stem 22 such that looking downwardly on the appliance button 10 from the top of the appliance 12 with the housing 14 removed, the button stem 22 would not be visible. The deflector 24 is also preferably larger than the button opening 18.

The deflector 24 extends at least partially toward the front and bottom ends 12a, 12c of the appliance 12 such that a front section 24a of the deflector 24 is at least partially convex to fit the shape of the housing 14 and to direct liquid as described in further detail below. A rear portion 24b of the deflector 24 preferably extends toward the rear 12b of the appliance 12 and is generally planer and tilted slightly toward the top of the appliance 12 due to the forward slant of the appliance buttons 10. The deflector 24 preferably includes a first side guide rail 26 proximate a first lateral side 24b of the deflector 24. The first side guide rail 26 extends upwardly toward the button opening 18. The deflector 24 also preferably includes a second side guide rail 28 proximate a second lateral side 24c of the deflector 24. The second side guide rail 28 extends upwardly toward the button opening 18. The first and second guide rails 26, 28 form a trough 30 therebetween for directing liquid (not shown) that enters the housing 14 through the button openings 18 toward the front end 12a of the appliance 12 away from the button stem 22. The first and last appliance buttons 10a, 10b within a row of a plurality of appliance buttons 10 preferably do not include an outer guide rail 26, 28. Instead, appliance buttons 10a, 10b preferably have an outer downward slant 26a, 28a. Though it is preferred that the deflector 24 have a convexly shaped front portion 24a and planer rear portion 24b and first and second guide rails 26, 28, the deflector 24 may be any shape capable of deflecting liquid that enters the housing 14 through the button openings 18 away from the button stem 22.

The appliance 12 preferably includes a thin protective water resistant cover 32 such as Mylar to surround at least the upper portion of the control structure 16. The cover 32 helps to protect the control structure 16 from liquid entering the control structure 16 and damaging the electrical components. However, because the button stems 22 must be slidingly disposed through the cover 32, there is potential that liquid will enter the control structure 16 between the cover 32 and the button stems 22. The deflectors 24 helps to deflect or direct the liquid entering through the housing 14 away from the button stems 22 such that liquid is prevented from entering the control structure 16 that would otherwise run down the button stems 22 past the cover 32.

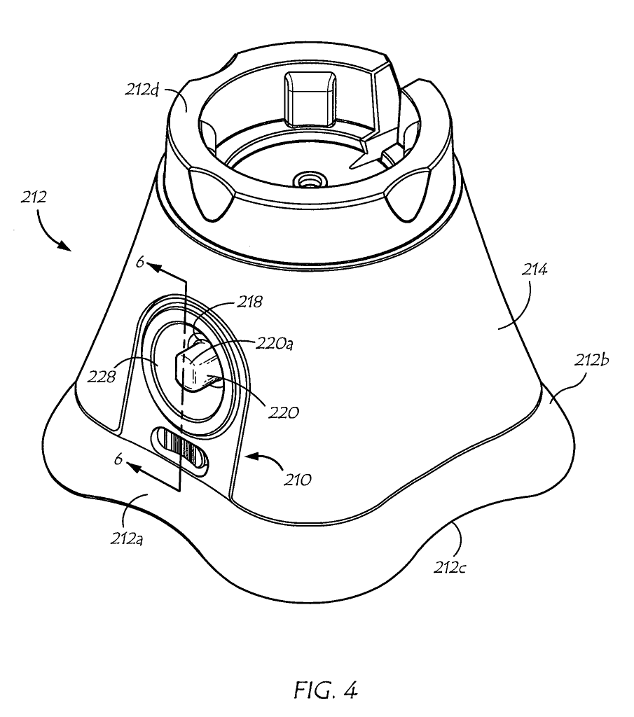

Referring to FIGS. 4-6, there is shown a second preferred embodiment of a control or appliance button, generally designated 210 for use in an appliance 212. The appliance button 210 of the second preferred embodiment is similar to the first preferred embodiment of the appliance button 10 except that the button 220 is a rotary knob type button.

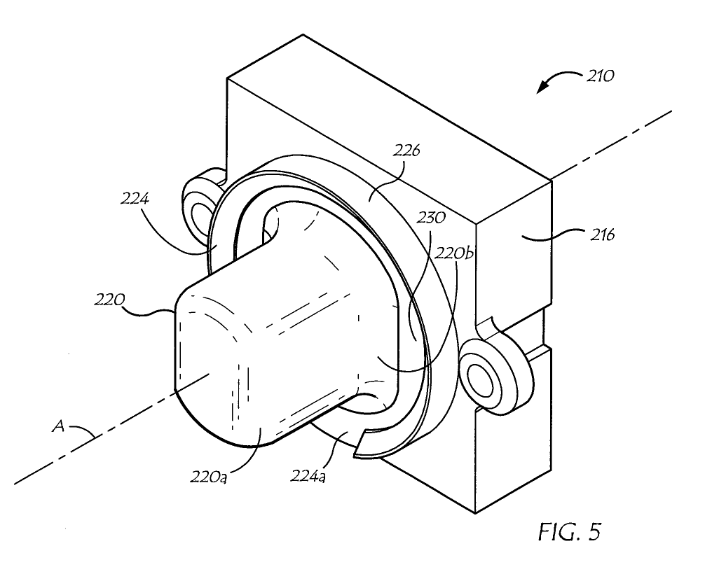

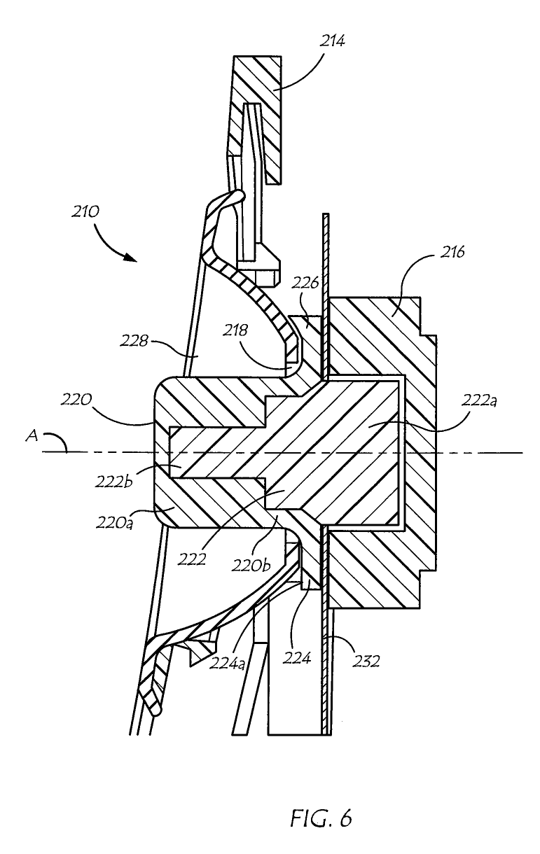

Referring to FIG. 4, the appliance 212 includes a housing 214. The housing 214 serves as a decorative body as well as a protective outer shell to protect a control box or structure 216 (FIG. 5) containing the electrical components within the housing 214. The details of the control structure 216 and the electrical components within are omitted for convenience only, as such details are well known in the art, and omission of such details is not limiting. The appliance 212 has a front end 212a a rear end 212b a bottom 212c for resting on a support surface (not shown) and a top 212d for receiving a blender jar (not shown). The appliance 212 and the housing 214 may have any suitable shape and configuration. The housing 214 includes a button opening 218 for receiving the appliance button 210. The housing 214 preferably includes a separately mounted recessed bezel 228. However, the bezel 228 and the housing 214 may be integrally formed. The appliance button 210 has a longitudinal axis A (FIGS. 5 and 6). The appliance button 210 is preferably a single rotary knob that is rotatable about the longitudinal axis A. However, the appliance button 210 may be any type of control such as a push and/or pull type button or a pivotable or sliding switch used to control the electric motor (not shown) within the housing 214 and may include more than one appliance button 210.

Referring to FIGS. 5-6, a distal end 220a of the button 220 extends outwardly through the button opening 218 in the housing 214. The button 220 is preferably at least slightly smaller than the size of the button opening 218 such that the button 220 can rotate or otherwise move with respect to the housing 214. The button 220 preferably has a generally cylindrical shape and is preferably molded from a polymeric material. However, the button 220 may be comprised of any shape such as rectangular and may be comprised of any suitable material such as metal. Additionally the button 220 may have a decorative cover knob (not shown) that is mounted or formed on the distal end 220a. The decorative cover knob may have an axially extending handle which fits within the bezel 228 as is known in the art.

Referring to FIG. 6, the appliance button 210 includes a button stem 222. The button stem 222 is generally co-axially aligned with the button 220. A first end 222a of the button stem 222 is operably connected to a device such as an electrical switch (not shown) within the control structure 216 and a second end 222b is operably connected to the button 220. The button 220 is preferably mounted over the second end 222b of the button stem 222. The button 222 is preferably slidably attached to the button stem 222. However, the button 220 may be secured to the button stem 222 in any manner such as a snap fit, use of adhesive or the like or that the push button 220 and the button stem 222 be integrally formed. As the button 220 is rotated, the button stem 222 rotates or otherwise activates the electrical switch (not shown) to operate one or more predetermined functions of the appliance 212. The button stem 222 preferably has a smaller radial dimensions than the button 220. However, the button stem 222 may have any shape and may be sized equal to or larger than the push button 220.

Referring to FIGS. 5 and 6, the appliance button 210 further includes a deflector 224. The deflector 224 is mounted on a proximal end 220b of the button 220 between the control structure 216 and the housing 214 or bezel 228. The button 220 and the deflector 224 are preferably integrally formed to prevent any space between the deflector 224 and the button 220. However, the button 220 and the deflector 224 may be separately formed and attached. The deflector 224 extends radially outwardly from the button 220 to direct liquid away from the button stem 222. The deflector 224 is preferably circular and is radially larger than the button opening 218. However, the deflector 224 may be any shape such as square, oval or triangular and need not necessarily be wider than the button opening 218.

The deflector 224 preferably includes at least one guide rail 226 that projects axially toward the housing 214 and is radially spaced from the button 220 to form at least one trough or liquid directing pathway 230. The guide rail 226 and the liquid directing pathway 230 preferably open toward a generally downwardly facing edge 224a of the deflector 224 such that liquid entering the liquid directing pathway 230 is guided along the guide rail 226 and then out the downwardly facing edge 224a.

Referring to FIG. 6, the appliance 212 preferably includes a thin protective water resistant cover 232 constructed of a polymeric material such as Mylar to surround at least the upper portion of the control structure 216. The cover 232 helps to protect the control structure 216 from liquid entering the control structure 216 and damaging the electrical components. However, because the button stem 222 must be rotatably disposed through the cover 232, there is potential that liquid will enter the control structure 216 between the cover 232 and the button stem 222. The deflector 224 helps to deflect or direct liquid entering through the housing 214 away from the button stem 222 such that liquid is prevented from entering the control structure 216 that would otherwise run down the button stem 222 past the cover 232.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

I claim:

1. An appliance button for use in an appliance having a housing, a button opening in the housing and a control structure within the housing, the appliance button comprising:
a button having a longitudinal axis, a distal end of the button extending outwardly through the button opening in the housing;
a button stem located within the housing and generally co-axially aligned with the button, a first end of the button stem operably connected to the control structure and a second end operably connected to the button; and
a deflector mounted on the button between the control structure and the housing and extending radially outwardly from the button to direct liquid away from the button stem.

2. The appliance button of claim 1, wherein the deflector includes at least one guide rail that projects axially toward the housing and is radially spaced from the button to form at least one liquid directing pathway.

3. The appliance button of claim 2, wherein the liquid directing pathway opens toward a downwardly facing edge of the deflector.

4. The appliance button of claim 1, wherein the button is a rotary knob rotatable about the longitudinal axis.

5. The appliance button of claim 1, wherein the deflector is circular.

6. The appliance button of claim 1, wherein the button and the deflector are integrally formed.

7. The appliance button of claim 1, wherein the button is mounted over the second end of the button stem.

8. The appliance button of claim 1, wherein the deflector is larger in a radial direction than the button opening.

9. The appliance button of claim 1 further comprising a water resistant film between the control structure and the deflector.

10. The appliance button of claim 1, wherein the appliance is a blender.
